(19) United States
(12) Patent Application Publication
(10) Pub. No.: US 2026/0019481 A1
(43) Pub. Date: Jan. 15, 2026

(54) FOLDABLE ELECTRONIC DEVICE

(71) Applicant: SYNCMOLD ENTERPRISE CORP., New Taipei City (TW)

(72) Inventors: Ching-Hui Yen, New Taipei City (TW); Chien-Cheng Yeh, New Taipei City (TW); Chun-Hao Huang, New Taipei City (TW)

(21) Appl. No.: 19/208,625

(22) Filed: May 15, 2025

Related U.S. Application Data
(60) Provisional application No. 63/670,373, filed on Jul. 12, 2024.

(30) Foreign Application Priority Data
Mar. 26, 2025 (TW) 114111502

(51) Int. Cl. H04M 1/02

(52) U.S. Cl. CPC H04M 1/0214

(57) ABSTRACT

A foldable electronic device is provided and includes a main panel body, a first folding module, a first wing panel body, a second folding module and a second wing panel body. The main panel body includes a first side and a second side opposite to the first side. The first folding module is disposed on the first side. The first wing panel body is disposed on the first folding module. The second folding module is disposed on the second side. The second wing panel body is disposed on the second folding module. When the foldable electronic device is in a folded state, the first wing panel body is stacked on the main panel body, the second wing panel body is stacked on the first wing panel body, and the first wing panel body is sandwiched between the main panel body and the second wing panel body.

### CROSS-REFERENCE TO RELATED APPLICATIONS

This application claims the benefit of U.S. Provisional Application Ser. No. 63/670,373 filed on Jul. 12, 2024, and the benefit of Taiwan Patent Application Serial No. 114111502 filed on Mar. 26, 2025. The entirety of each application is incorporated herein by reference.

### BACKGROUND

### 1. Technical Field

The present disclosure relates to a foldable electronic device, and more particularly, to a foldable electronic device having a G-shaped cross-section in a folded state.

### 2. Description of Related Art

Flexible screens have been widely applied in smartphones and tablet computers. If a structure for supporting the flexible screen is not well designed, a bendable area of the flexible screen may be damaged when folded, or the flexible screen may not be completely flattened when unfolded, which may cause troubles to users. Conventional tri-fold electronic devices two sets of same connecting rod structures, so that the tri-fold electronic devices generally have an S-shaped cross-section in a folded state. However, the current tri-fold electronic devices still leave parts of the flexible screens exposed after being folded, so risks of being damaged by impact for the flexible screens are increased.

### SUMMARY

The present disclosure provides a foldable electronic device, which comprises: a main panel body including a first side and a second side opposite each other; a first folding module connected to the first side; a first wing panel body disposed on the first folding module, and capable of rotating relative to the main panel body roughly with the first folding module as an axis; a second folding module disposed on the second side; a second wing panel body connected to the second folding module, and capable of rotating relative to the main panel body roughly with the second folding module as an axis; and a flexible screen disposed on the main panel body, the first folding module, the first wing panel body, the second folding module and the second wing panel body, and including a first bendable area corresponding to the first folding module and a second bendable area corresponding to the second folding module, wherein the foldable electronic device is able to be changed between an unfolded state and a folded state, wherein when in the unfolded state, the flexible screen is flattened, the main panel body, the first wing panel body and the second wing panel body are flattened, the first folding module supports the first bendable area, and the second folding module supports the second bendable area, wherein when in the folded state, the flexible screen is bent, the first wing panel body is stacked on the main panel body, the second wing panel body is stacked on the first wing panel body, and the first wing panel body is sandwiched between the main panel body and the second wing panel body, and wherein the first folding module defines a first accommodating space to accommodate the first bendable area, the second folding module defines a second accommodating space to accommodate the second bendable area, and the main panel body and the second wing panel body extend roughly parallel to each other and are spaced apart.

In the aforementioned foldable electronic device, the foldable electronic device is further able to be changed into a single-inflexed state, and wherein, in the single-inflexed state, the first wing panel body and the main panel body are flattened, the main panel body, the second wing panel body and the second folding module collectively form a U-shaped cross-section, and the main panel body does not contact the second wing panel body.

In the aforementioned foldable electronic device, in the folded state, the first accommodating space is in a water drop shape, and the second accommodating space is with a U-shaped cross-section.

In the aforementioned foldable electronic device, in the folded state, the main panel body, the first wing panel body and the second wing panel body collectively have a G-shaped cross-section.

In the aforementioned foldable electronic device, the first folding module is mechanically different from the second folding module.

In the aforementioned foldable electronic device, the first folding module is a waterdrop-shaped connecting rod structure, and the second folding module is a U-shaped connecting rod structure.

In the aforementioned foldable electronic device, a width of the first wing panel body is smaller than a width of the main panel body, and a width of the second wing panel body is larger than the width of the first wing panel body and larger than the width of the main panel body.

In the aforementioned foldable electronic device, the flexible screen further includes a first side display area, a main display area and a second side display area, wherein the first side display area corresponds to the first wing panel body, the main display area corresponds to the main panel body, and the second side display area corresponds to the second wing panel body, and wherein the first bendable area is located between the first side display area and the main display area, and the second bendable area is located between the main display area and the second side display area.

In the aforementioned foldable electronic device, in the folded state, the first side display area is adjacent to the main display area, and the second side display area is away from the first side display area and the main display area.

In the aforementioned foldable electronic device, the first bendable area has two small bending sections and one large bending section, wherein the large bending section is located between the small bending sections, and the small bending sections are respectively connected to the first side display area and the main display area, and wherein, in the folded state, the first side display area and the main display area extend roughly parallel to each other via bending of the small bending sections.

In the aforementioned foldable electronic device, the first folding module includes a first central base, a first pivot module, a first right wing member, a first right transmission member, a first right carrying member, a first right drop plate, a first left wing member, a first left transmission member, a first left carrying member, a first left drop plate, a first synchronization module and a first elastic module.

In the aforementioned foldable electronic device, the second folding module includes a second central base, a second pivot module, a second right wing member, a second right transmission member, a second left wing member, a second left transmission member, a second synchronization module and a second elastic module.

In the aforementioned foldable electronic device, a width of the first central base is smaller than a width of the second central base.

In summary, the foldable electronic device of the present disclosure has a G-shaped cross-section when folded, so that the flexible screen is not exposed, thereby reducing the risk of the flexible screen being damaged by impact.

### BRIEF DESCRIPTION OF THE DRAWINGS

FIG. 1 is a schematic exploded view of a foldable electronic device according to the present disclosure in an unfolded state.

FIG. 2 is a schematic exploded view of the foldable electronic device according to the present disclosure.

FIG. 3 is a schematic exploded view of a first folding module of the foldable electronic device according to the present disclosure.

FIG. 4 is a schematic exploded view of a second folding module of the foldable electronic device according to the present disclosure.

FIG. 5 is an overall schematic view of the foldable electronic device according to the present disclosure in a folded state.

FIG. 6 is a schematic cross-sectional view of the foldable electronic device according to the present disclosure in the folded state.

FIG. 7 is a side view of the foldable electronic device according to the present disclosure in a single-inflexed state.

### DETAILED DESCRIPTION

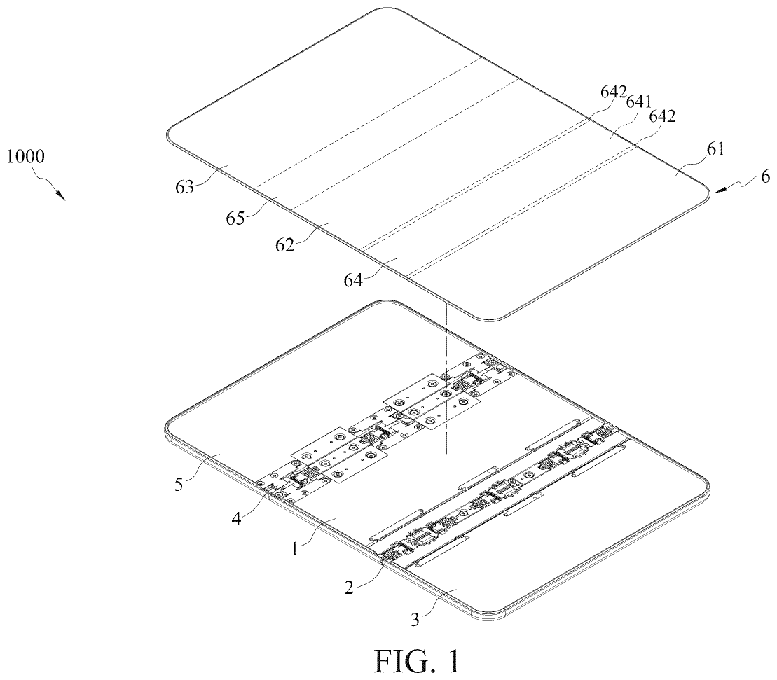

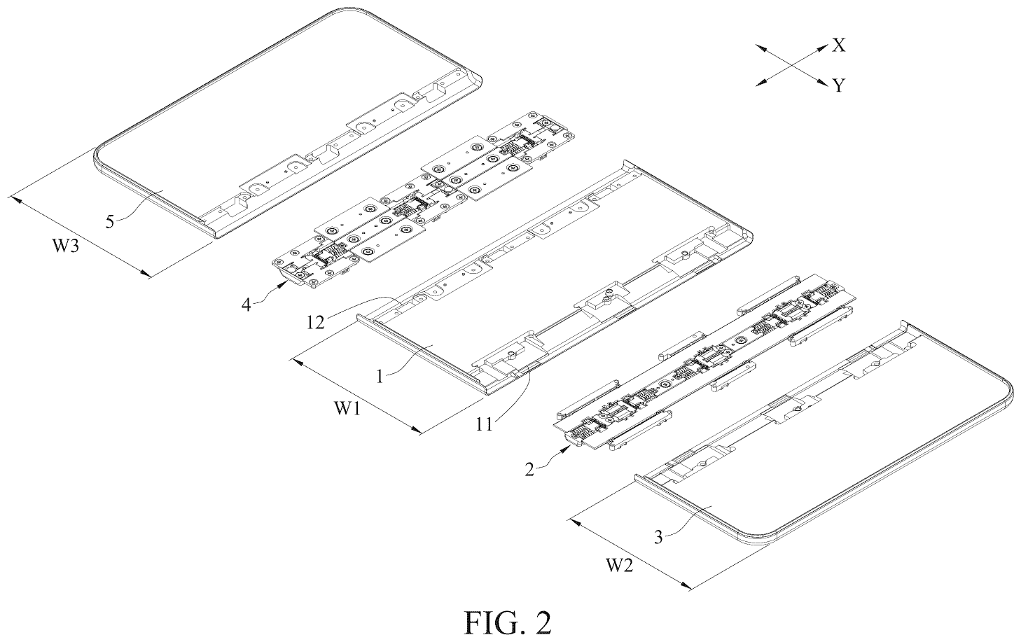

Referring to FIG. 1 and FIG. 2, a foldable electronic device 1000 of the present disclosure comprises a main panel body 1, a first folding module 2, a first wing panel body 3, a second folding module 4, a second wing panel body 5 and a flexible screen 6. In other words, the foldable electronic device 1000 of the present disclosure is a double-inflexed foldable electronic device. Some of the diagrams show a first direction X and a second direction Y that are perpendicular to each other. The structure of each of the components and the connection relationship between the components will be described in detail below.

The main panel body 1 is roughly a rectangular plate body and includes a first side 11 and a second side 12 opposite to the first side 11, wherein the first side 11 and the second side 12 extend along the first direction X. The main panel body 1 has a width W1 in the second direction Y.

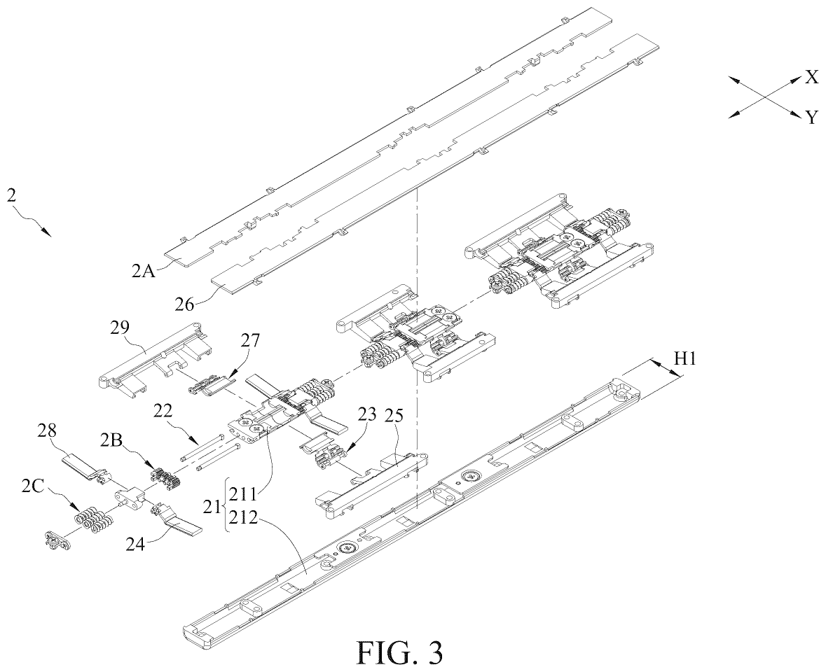

Please refer to FIG. 3, the first folding module 2 includes a first central base 21, a first pivot module 22, a first right wing member 23, a first right transmission member 24, a first right carrying member 25, a first right drop plate 26, a first left wing member 27, a first left transmission member 28, a first left carrying member 29, a first left drop plate 2A, a first synchronization module 2B and a first elastic module 2C.

The first central base 21 has a first body portion 211 and a first shell 212. The first body portion 211 is in the shape of an elongated block and is disposed on the first shell 212. The extension direction of the first shell 212 is parallel to the extension direction of the first side 11, and the first shell 212 has a width H1 along the second direction Y. The first pivot module 22 is disposed on the first body portion 211 of the first central base 21. The first right wing member 23 and the first left wing member 27 are respectively pivotally connected to two sides of the first body portion 211 of the first central base 21. The first right transmission member 24 and the first left transmission member 28 are respectively connected to the first pivot module 22, the first synchronization module 2B and the first elastic module 2C. The first right carrying member 25 is connected to the first right wing member 23 and the first right transmission member 24. The first right drop plate 26 is connected to the first right wing member 23 and the first right carrying member 25. The first left carrying member 29 is connected to the first left wing member 27 and the first left transmission member 28, and is fixedly connected to the first side 11 of the main panel body 1. The first left drop plate 2A is connected to the first left wing member 27 and the first left carrying member 29. The first synchronization module 2B is disposed between the first body portion 211 of the first central base 21 and the first pivot module 22, and is connected to the first right transmission member 24 and the first left transmission member 28, so that the first right transmission member 24 and the first left transmission member 28 can rotate synchronously and reversely. The first elastic module 2C is disposed on the first shell 212 of the first central base 21 and is connected to the first pivot module 22 to provide a constant elastic force.

In one embodiment, the first folding module 2 is a waterdrop-shaped connecting rod structure. It should be noted that some components in the first folding module 2 of the present disclosure may consist of one set or a plurality of sets, all of which can achieve the operational effect of the present disclosure. For example, the first pivot module 22, the first right transmission member 24, the first left transmission member 28, the first synchronization module 2B and the first elastic module 2C may be arranged in two sets, which are arranged on opposite sides of the first body portion 211 of the first central base 21 in a mirror-symmetrical manner. For another example, the number of the first folding modules 2 may consist of a plurality of sets, which are disposed and spaced apart from each other on the first side 11 of the main panel body 1. At this time, the plurality of sets of first folding modules 2 can share a single first shell 212, but the present disclosure is not limited to as such.

The first wing panel body 3 is roughly a rectangular plate body and is fixedly connected to the first right carrying member 25 of the first folding module 2, thereby the first wing panel body 3 can rotate relative to the main panel body 1 with the first folding module 2 as an axis. The first wing panel body 3 has a width W2 in the second direction Y.

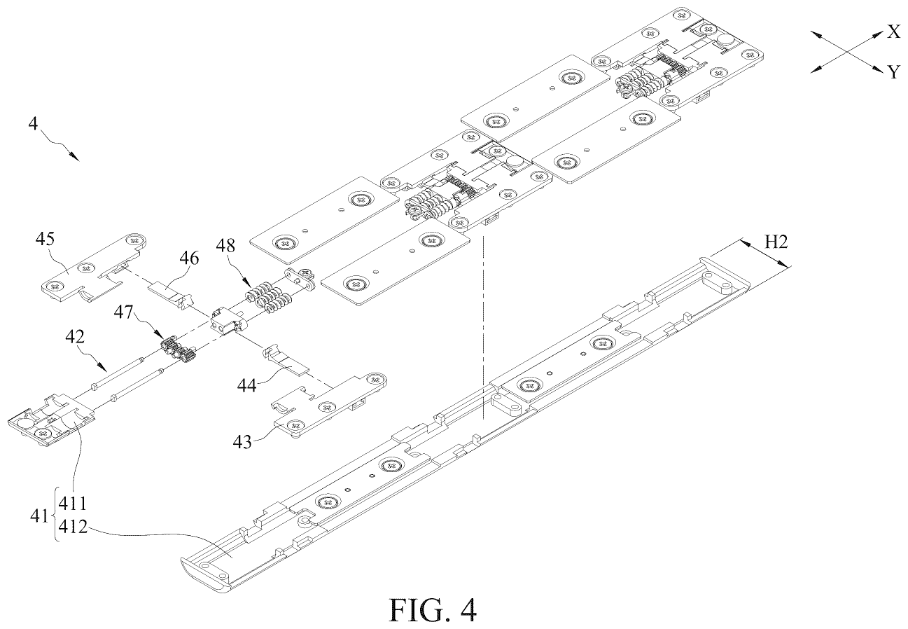

Please refer to FIG. 4, the second folding module 4 includes a second central base 41, a second pivot module 42, a second right wing member 43, a second right transmission member 44, a second left wing member 45, a second left transmission member 46, a second synchronization module 47 and a second elastic module 48.

The second central base 41 has a second body portion 411 and a second shell 412. The second body portion 411 is in the shape of an elongated block and is disposed on the second shell 412. The extension direction of the second shell 412 is parallel to the extension direction of the second side 12, and the second shell 412 has a width H2 along the second direction Y. The second pivot module 42 is disposed on the second body portion 411 of the second central base 41. The second right wing member 43 and the second left wing member 45 are respectively pivotally connected to two sides of the second body portion 411 of the second central base 41, and the second right wing member 43 is fixedly connected to the second side 12 of the main panel body 1. The second right transmission member 44 and the second left transmission member 46 are connected to the second pivot module 42, the second synchronization module 47 and the second elastic module 48, and are slidably disposed in the second right wing member 43 and the second left wing member 45, respectively. The second synchronization module 47 is disposed between the second body portion 411 of the second central base 41 and the second pivot module 42, and is connected to the second right transmission member 44 and the second left transmission member 46, so that the second right transmission member 44 and the second left transmission member 46 can rotate synchronously and reversely. The second elastic module 48 is disposed on the second shell 412 of the second central base 41 and is connected to the second pivot module 42 to provide a constant elastic force.

In one embodiment, the second folding module 4 is a U-shaped connecting rod structure. Namely, the second folding module 4 is mechanically different from the first folding module 2. It should be noted that the number of the second folding modules 4 of the present disclosure may consist of a plurality of sets, which are disposed and spaced apart from each other on the second side 12 of the main panel body 1. At this time, the plurality of sets of second folding modules 4 can share a single second shell 412, but the present disclosure is not limited to as such.

The second wing panel body 5 is roughly a rectangular plate body and is fixedly connected to the second left wing member 45 of the second folding module 4, thereby the second wing panel body 5 can rotate relative to the main panel body 1 with the second folding module 4 as an axis. The second wing panel body 5 has a width W3 in the second direction Y.

The flexible screen 6 is disposed on the main panel body 1, the first folding module 2, the first wing panel body 3, the second folding module 4 and the second wing panel body 5, and includes a first side display area 61, a main display area 62, a second side display area 63, a first bendable area 64 and a second bendable area 65. The first side display area 61 corresponds to the first wing panel body 3. The main display area 62 corresponds to the main panel body 1. The second side display area 63 corresponds to the second wing panel body 5. The first bendable area 64 corresponds to the first folding module 2, and is located between the first side display area 61 and the main display area 62, and has a large bending section 641 and two small bending sections 642. The large bending section 641 is located between the small bending sections 642, and the small bending sections 642 are respectively connected to the first side display area 61 and the main display area 62. The second bendable area 65 corresponds to the second folding module 4 and is located between the main display area 62 and the second side display area 63.

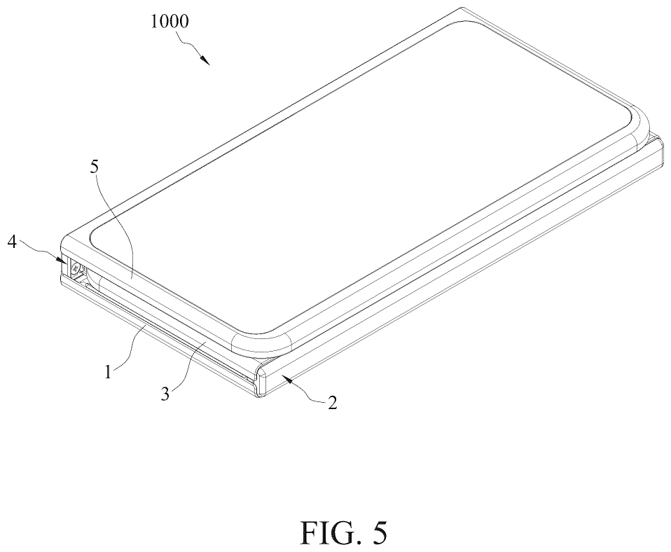

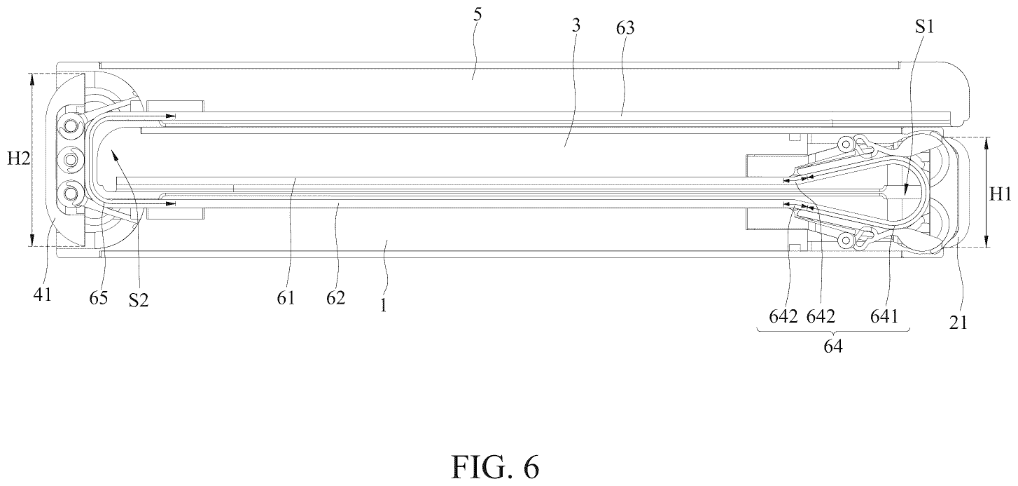

The following describes the operation of the foldable electronic device 1000 of the present disclosure. The foldable electronic device 1000 can be changed between an unfolded state (FIG. 1) and a folded state (FIG. 5 and FIG. 6). In the unfolded state, the flexible screen 6 is flattened, and the main panel body 1, the first wing panel body 3 and the second wing panel body 5 are flattened, wherein the first folding module 2 supports the first bendable area 64, and the second folding module 4 supports the second bendable area 65.

When the foldable electronic device 1000 is changed from the unfolded state to the folded state, the first wing panel body 3 rotates relative to the main panel body 1 with the first folding module 2 as an axis, and is stacked on the main panel body 1, and the second wing panel body 5 rotates relative to the main panel body 1 with the second folding module 4 as an axis, and is stacked on the first wing panel body 3, so that the first wing panel body 3 is sandwiched between the main panel body 1 and the second wing panel body 5. Moreover, the main panel body 1 and the second wing panel body 5 extend roughly parallel to each other and are spaced apart, that is, a double-inflexed folding state. As the first wing panel body 3 and the second wing panel body 5 rotate, the flexible screen 6 is synchronously bent, wherein the first folding module 2 simultaneously defines a first accommodating space S1 in the shape of a water drop, and the second folding module 4 simultaneously defines a second accommodating space S2 in the shape of a U. The first accommodating space S1 accommodates the first bendable area 64, and the second accommodating space S2 accommodates the second bendable area 65 and the first wing panel body 3, wherein the large bending section 641 is bent in a different direction than the small bending sections 642, and the extent of the bending of the large bending section 641 is greater than the extent of the bending of the small bending sections 642, so as to form a waterdrop-shaped cross-section.

As shown in FIG. 6, the width H1 of the first shell 212 of the first central base 21 is smaller than the width H2 of the second shell 412 of the second central base 41, the width W2 of the first wing panel body 3 is smaller than the width W1 of the main panel body 1, and the width W3 of the second wing panel body 5 is larger than the width W2 of the first wing panel body 3 and the width W1 of the main panel body 1. Therefore, in the folded state, the main panel body 1, the first wing panel body 3 and the second wing panel body 5 collectively have a G-shaped cross-section. At this time, the first side display area 61 and the main display area 62 extend roughly parallel to each other via the small bending sections 642, and the first side display area 61 is adjacent to the main display area 62. The second side display area 63 extends roughly parallel to the first side display area 61 via the second bendable area 65, and is away from the first side display area 61 and the main display area 62.

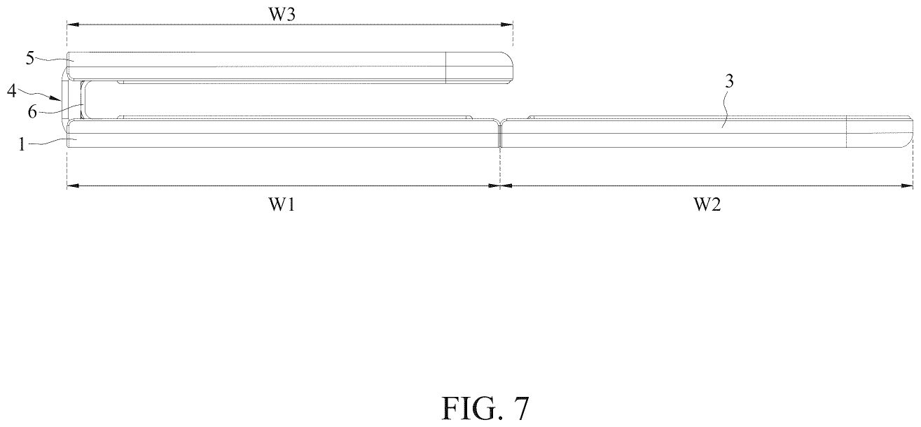

As shown in FIG. 7, the foldable electronic device 1000 can be further changed into a single-inflexed state. In the single-inflexed state, the first wing panel body 3 and the main panel body 1 are flattened, and the second wing panel body 5 rotates relative to the main panel body 1 with the second folding module 4 as an axis, so that the main panel body 1, the second wing panel body 5 and the second folding module 4 collectively form a U-shaped cross-section, and the second wing panel body 5 is suspended above the main panel body 1 without contacting the main panel body 1. In order to enable the main panel body 1, the second wing panel body 5 and the second folding module 4 to maintain the U-shaped cross-section in the single-inflexed state, the second right transmission member 44, the second left transmission member 46 and the second elastic module 48 can have corresponding structures. For example, the second right transmission member 44, the second left transmission member 46 and the second elastic module 48 respectively have an end cam that can match each other, and the end cam has a plurality of convex portions and a plurality of concave portions respectively formed between any two of the plurality of convex portions. By designing the number of convex and concave portions such that when one of the convex portions rotates from the position of one of the concave portions to the position of another concave portion, the rotation angle of one of the convex portions allows the main panel body 1, the second wing panel body 5 and the second folding module 4 to form a U-shaped cross-section in the single-inflexed state, and the engagement structure formed by the convex portions extending into the concave portions serves as a stopping point to maintain the U-shaped cross-section, but the present disclosure is not limited to as such. Suitable stopping points may also be provided elsewhere, such as on the path of the second right wing member 43 and the second left wing member 45 pivoting relative to the second central base 41, and the like.

To sum up, the foldable electronic device of the present disclosure has a G-shaped cross-section when folded via two different folding modules, so that the flexible screen is not exposed, thereby reducing the risk of the flexible screen being damaged by impact.

What is claimed is:

1. A foldable electronic device, comprising:
a main panel body including a first side and a second side opposite each other;
a first folding module disposed on the first side;
a first wing panel body connected to the first folding module, and capable of rotating relative to the main panel body roughly with the first folding module as an axis;
a second folding module disposed on the second side;
a second wing panel body connected to the second folding module, and capable of rotating relative to the main panel body roughly with the second folding module as an axis; and
a flexible screen disposed on the main panel body, the first folding module, the first wing panel body, the second folding module and the second wing panel body, and including a first bendable area corresponding to the first folding module and a second bendable area corresponding to the second folding module,
wherein the foldable electronic device is able to be changed between an unfolded state and a folded state, wherein when in the unfolded state, the flexible screen is flattened, the main panel body, the first wing panel body and the second wing panel body are flattened, the first folding module supports the first bendable area, and the second folding module supports the second bendable area, wherein when in the folded state, the flexible screen is bent, the first wing panel body is stacked on the main panel body, the second wing panel body is stacked on the first wing panel body, and the first wing panel body is sandwiched between the main panel body and the second wing panel body, and wherein the first folding module defines a first accommodating space to accommodate the first bendable area, the second folding module defines a second accommodating space to accommodate the second bendable area, and the main panel body and the second wing panel body extend roughly parallel to each other and are spaced apart.

2. The foldable electronic device of claim 1, wherein the foldable electronic device is further able to be changed into a single-inflexed state, and wherein, in the single-inflexed state, the first wing panel body and the main panel body are flattened, the main panel body, the second wing panel body and the second folding module collectively form a U-shaped cross-section, and the main panel body does not contact the second wing panel body.

3. The foldable electronic device of claim 2, wherein, in the folded state, the first accommodating space is in a water drop shape, and the second accommodating space is with a U-shaped cross-section.

4. The foldable electronic device of claim 3, wherein, in the folded state, the main panel body, the first wing panel body and the second wing panel body collectively have a G-shaped cross-section.

5. The foldable electronic device of claim 4, wherein the first folding module is mechanically different from the second folding module.

6. The foldable electronic device of claim 5, wherein the first folding module is a waterdrop-shaped connecting rod structure, and the second folding module is a U-shaped connecting rod structure.

7. The foldable electronic device of claim 6, wherein a width of the first wing panel body is smaller than a width of the main panel body, and a width of the second wing panel body is larger than the width of the first wing panel body and larger than the width of the main panel body.

8. The foldable electronic device of claim 7, wherein the flexible screen further includes a first side display area, a main display area and a second side display area, wherein the first side display area corresponds to the first wing panel body, the main display area corresponds to the main panel body, and the second side display area corresponds to the second wing panel body, and wherein the first bendable area is located between the first side display area and the main display area, and the second bendable area is located between the main display area and the second side display area.

9. The foldable electronic device of claim 8, wherein, in the folded state, the first side display area is adjacent to the main display area, and the second side display area is away from the first side display area and the main display area.

10. The foldable electronic device of claim 9, wherein the first bendable area has two small bending sections and one large bending section, wherein the large bending section is located between the small bending sections, and the small bending sections are respectively connected to the first side display area and the main display area, and wherein, in the folded state, the first side display area and the main display area extend roughly parallel to each other via bending of the small bending sections.

11. The foldable electronic device of claim 1, wherein the first folding module includes a first central base, a first pivot module, a first right wing member, a first right transmission member, a first right carrying member, a first right drop plate, a first left wing member, a first left transmission member, a first left carrying member, a first left drop plate, a first synchronization module and a first elastic module.

12. The foldable electronic device of claim 11, wherein the second folding module includes a second central base, a second pivot module, a second right wing member, a second right transmission member, a second left wing member, a second left transmission member, a second synchronization module and a second elastic module.

13. The foldable electronic device of claim 12, wherein a width of the first central base is smaller than a width of the second central base.
